(19) United States
(12) Patent Application Publication
(10) Pub. No.: US 2015/0239206 A1
(43) Pub. Date: Aug. 27, 2015

(54) FABRIC STRUCTURE

(71) Applicant: MACKENT FABRICS CO., LTD., Taoyuan City (TW)

(72) Inventor: Tai-Li HSIAO, Taoyuan City (TW)

(21) Appl. No.: 14/445,337

(22) Filed: Jul. 29, 2014

(30) Foreign Application Priority Data
Feb. 27, 2014 (TW) 103203509

(51) Int. Cl. B32B 5/02; A41C 3/12; B32B 3/28; B32B 5/26; B32B 5/04

(52) U.S. Cl. CPC B32B 5/024; B32B 5/26; B32B 5/04; B32B 3/28; A41C 3/12; B32B 2250/03; B32B 2250/20; B32B 2437/00

(57) ABSTRACT

An improved fabric structure of the present invention comprises an upper fabric layer, a middle fabric layer and a lower fabric layer stacked in this order. The middle fabric layer is corrugated, and a part of the middle fabric layer has a weaving density and another part of the middle fabric layer has another weaving density which is different from the weaving density. Accordingly, the purpose of improving the supportability, the softness and the breathability can be achieved. The upper fabric layer may be a woven fabric layer and has a plurality of jacquard patterns, and in this way, the purpose of improving the texture and reducing the number of production steps can be achieved.

### BACKGROUND OF THE INVENTION

1. Technical Field

The present invention relates to an improved fabric structure as a brand new development concept, and particularly, to an improved fabric structure capable of improving the supportability, softness, breathability and the texture and also reducing the number of production steps.

2. Description of Related Art

For fabric structures such as clothes, trousers or the like that are worn daily by users, more and more requirements have been imposed by the users, for example, a good heat dissipation effect, breathability, sweat absorbing ability, a feeling of comfort, and lightness. Accordingly, various weaving processes or fiber arrangement structures or different fiber materials have been developed for the fabric structures such as the clothes and trousers.

Taking the women's underwear as an example, the underwear worn by the women is required to not only provide good support for the women's breasts, but also have good breathability to avoid a feeling of uncomfortableness. Even further, some women may expect a good sense of texture in appearance of the underwear.

However, the women's underwear currently sold in the market (e.g., the common underwear made of the spacer fabrics) is not so good as expected in terms of the supportability and the feeling of comfort, and the patterns are all formed through printing. However, the dyes printed tend to be discolored when the underwear is washed, and the printed patterns appear to be lacking in the sense of texture, so there is still a room for improvement of the conventional underwear.

### BRIEF SUMMARY OF THE INVENTION

An improved fabric structure of the present invention comprises an upper fabric layer, a middle fabric layer and a lower fabric layer stacked in this order. The middle fabric layer is corrugated, and a part of the middle fabric layer has a weaving density and another part of the middle fabric layer has another weaving density which is different from the weaving density.

Therefore, with the aforesaid structural design, the purpose of improving the supportability, the softness and the breathability can be achieved.

A further part of the aforesaid middle fabric layer has a further weaving density which is different from the weaving density and the another weaving density.

The aforesaid upper fabric layer is a woven fabric layer and has a plurality of jacquard patterns. With the aforesaid design, the purpose of improving the texture and reducing the number of production steps (e.g., a production step for printing patterns is saved) can be achieved.

The aforesaid lower fabric layer is an elastic fabric layer (e.g., an elastic fiber layer).

### BRIEF DESCRIPTION OF THE SEVERAL VIEWS OF THE DRAWINGS

FIG. 1 is a perspective view of a preferred embodiment of the present invention;

FIG. 2 is a schematic view illustrating the use of the preferred embodiment of the present invention;

FIG. 3 is a schematic view illustrating a woven fabric layer of the preferred embodiment of the present invention;

FIG. 4 is another schematic view illustrating the woven fabric layer of the preferred embodiment of the present invention; and

FIG. 5 is a perspective view of another preferred embodiment of the present invention.

### DETAILED DESCRIPTION OF THE INVENTION

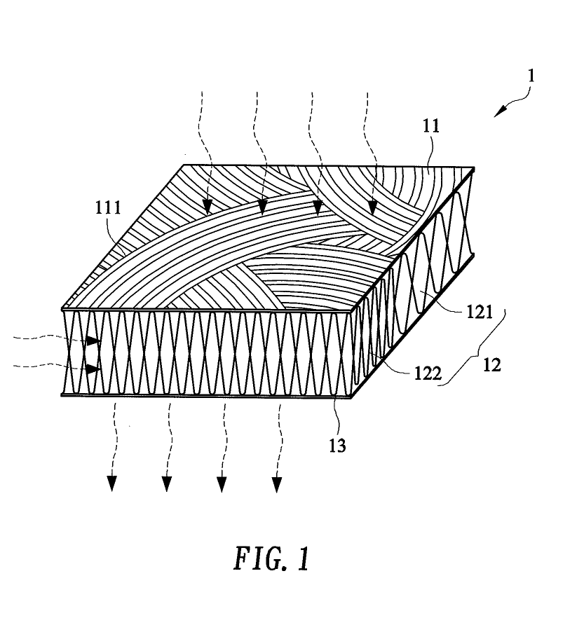

Referring to FIG. 1, there is shown a perspective view of a preferred embodiment of the present invention.

FIG. 1 shows an improved fabric structure 1, which comprises an upper fabric layer 11, a middle fabric layer 12 and a lower fabric layer 13 stacked in this order.

In other words, the aforesaid improved fabric structure 1 comprises a three-layered fabric layer, i.e., the so-called spacer fabric (as known as the sandwich mesh fabric) formed through a three-dimensional weaving process.

As can be known from FIG. 1, the middle fabric layer 12 is corrugated, and a part 121 of the middle fabric layer 12 has a weaving density and another part 122 of the middle fabric layer 12 has another weaving density.

In this embodiment, the weaving density of the part 121 of the middle fabric layer 12 is different from the another weaving density of the another part 122 of the middle fabric layer 12. Of course, the middle fabric layer 12 may also have a third weaving density, a fourth weaving density and etc. (e.g., a further part of the middle fabric layer has a further weaving density which is different from the weaving density and the another weaving density) depending on the actual need. In other words, a number of different parts of the middle fabric layer 12 may each have a different weaving density, and the different parts may be located at any locations of the middle fabric layer 12.

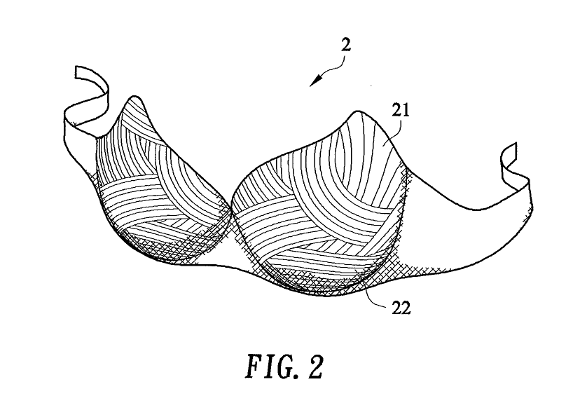

Referring to FIG. 2, there is shown a schematic view illustrating the use of the preferred embodiment of the present invention.

FIG. 2 shows a women's underwear 2, which is formed of the improved fabric structure 1 shown in FIG. 1 and FIG. 2.

When the underwear 2 shown in FIG. 2 is worn, a good penetration effect (e.g., moisture-penetrability, breathability (heat dissipation) and etc.) can be achieved through the structure of the corrugated middle fabric layer 12, as shown by an arrow in FIG. 1.

Furthermore, in FIG. 2, the middle fabric layer 12 has a smaller density in the upper portion 21 of the underwear 2, and has a larger density in the lower portion 22 of the underwear 2. Specifically, the upper portion 21 of the underwear 2 with the smaller density can have a good softness, while the lower portion 22 of the underwear 2 with the larger density can have a good supportability.

In other words, the weaving densities of the different parts of the same middle fabric layer 12 may vary depending on the actual need. For the underwear 2 shown in FIG. 2, the lower portion 22 of the underwear 2 has a larger density so that when the underwear 2 is worn, it can provide good support for the breasts and can lift the breasts and/or place the two breasts closer together; and the upper portion 21 of the underwear 2 has a smaller density so that when the underwear 2 is worn, it can provide good softness to enhance the feeling of comfort for a user who wears the underwear 2.

Furthermore, the upper fabric layer 11 in this embodiment is a woven fabric layer and has a plurality of jacquard patterns 111. Because the upper fabric layer 11 is a woven fabric layer and has a plurality of jacquard patterns 111, the underwear 2 formed of the improved fabric structure 1 can provide good breathability when it is worn and the jacquard patterns 111 can also provide a good sense of texture. Even further, because the upper fabric layer 11 is a woven fabric layer, the production step for printing patterns as used in the conventional practice can be saved and the problem that the dyes printed tend to be discolored when the underwear is washed can be prevented correspondingly. That is, with the aforesaid structural design, the purpose of improving the breathability and the texture and reducing the number of production steps can be achieved.

Further in this embodiment, when the underwear 2 is worn, the lower fabric layer 13 is in close contact with the skin. The lower fabric layer 13 may be designed to be a general fiber layer or an elastic fiber layer (an elastic fabric layer). In case of an elastic fiber layer (e.g., an elastic fiber layer made of 100% elastic fibers), such properties of the elastic fibers as good elasticity, a good elastic recovery rate, good softness and comfortableness, and slight viscosity can help to improve the supportability (for the breasts) and make the lower fabric layer 13 in closer contact with the skin.

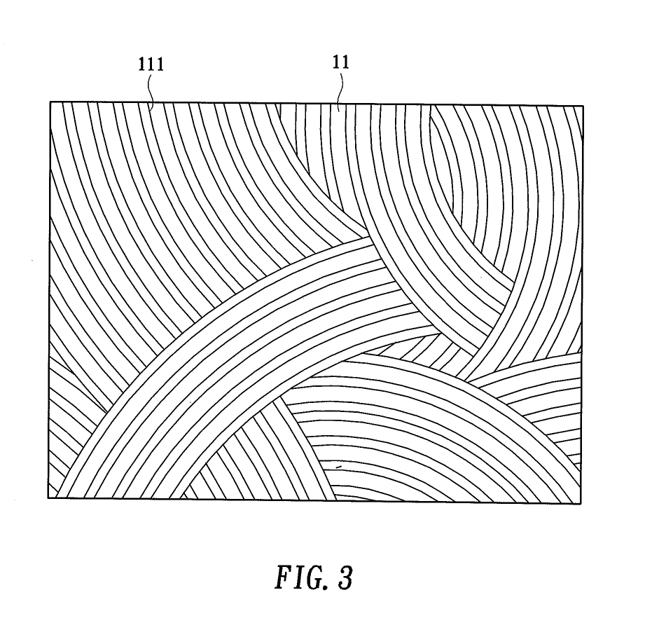

Referring to FIG. 3, there is shown a schematic view illustrating a woven fabric layer of the preferred embodiment of the present invention. As shown in FIG. 3, if the fibers used are relatively thick or the number of stitches is great during the weaving, the final product will become opaque in appearance.

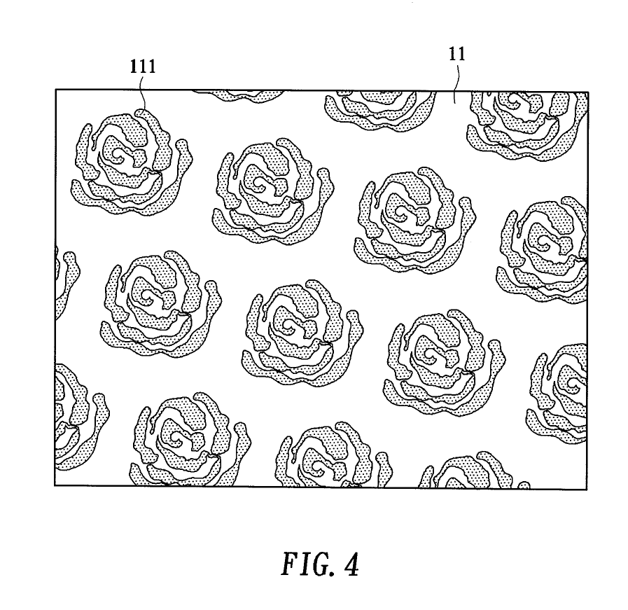

Referring to FIG. 4, there is shown another schematic view illustrating the woven fabric layer of the preferred embodiment of the present invention. As shown in FIG. 4, if the fibers used are relatively thin or the number of stitches is small during the weaving, the final product will become translucent in appearance.

Therefore, as can be known from FIG. 3 and FIG. 4, by varying the thickness of the fibers used and the number of stitches during the weaving, the woven fabric layer may be made to have a transparent or translucent feeling of texture.

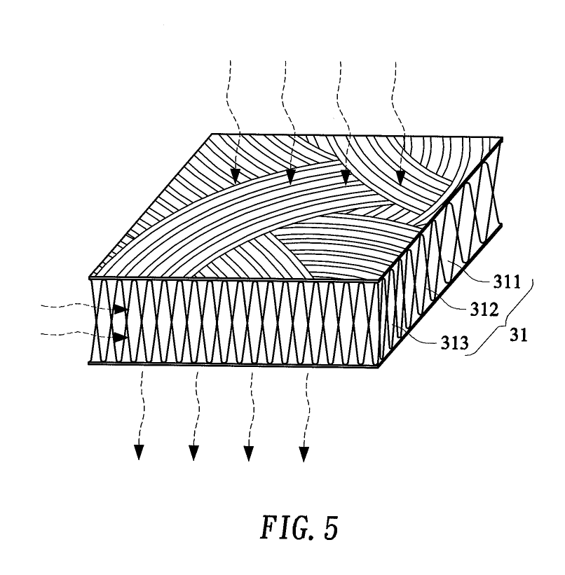

Referring to FIG. 5, there is shown a perspective view of another preferred embodiment of the present invention.

In the preferred embodiment shown in FIG. 5, the middle fabric layer 31 has three parts, each of which has a different weaving density.

Specifically, a part 311 of the middle fabric layer 31 has a weaving density; another part 312 of the middle fabric layer 31 has another weaving density; and a further part 313 of the middle fabric layer 31 has a further weaving density which is different from the weaving density and the another weaving density.

Accordingly, as described above, the middle fabric layer may be made to have different weaving densities in a number of different parts thereof depending on the actual need (e.g., the need for good softness or good supportability of a certain part of the middle fabric layer).

1. An improved fabric structure, comprising an upper fabric layer, a middle fabric layer and a lower fabric layer stacked in this order, wherein the middle fabric layer is corrugated, and a part of the middle fabric layer has a weaving density and another part of the middle fabric layer has another weaving density which is different from the weaving density.

2. The improved fabric structure of claim 1, wherein a further part of the middle fabric layer has a further weaving density which is different from the weaving density and the another weaving density.

3. The improved fabric structure of claim 1, wherein the upper fabric layer is a woven fabric layer and has a plurality of jacquard patterns.

4. The improved fabric structure of claim 1, wherein the lower fabric layer is an elastic fabric layer.
